(19) United States
(12) Patent Application Publication
(10) Pub. No.: US 2016/0020618 A1
(43) Pub. Date: Jan. 21, 2016

(54) Fast Charge Algorithms for Lithium-Ion Batteries

(71) Applicant: Ford Global Technologies, LLC, Dearborn, MI (US)

(72) Inventors: Xiao Guang Yang, Northville, MI (US); Theodore James Miller, Milan, MI (US)

(21) Appl. No.: 14/336,741

(22) Filed: Jul. 21, 2014

(51) Int. Cl. H02J 7/00

(52) U.S. Cl. CPC H02J 7/007; H02J 7/0052

(57) ABSTRACT

Electric and plug-in hybrid vehicles include a traction battery to provide vehicle power. The battery may be operated in a charge-depleting mode and require recharging from an external power source. Fast charging of the traction battery is achieved by allowing a charging voltage greater than a recommended charging voltage. The charging voltage is based on the charging current and an internal resistance of the traction battery. The resistance value may be estimated during charging to allow a dynamic maximum charging voltage. Charging may be terminated based on voltage, temperature, state of charge or time criteria. The fast charging allows the traction battery to be charged in a relatively fast period of time.

### TECHNICAL FIELD

This application is generally related to charging lithium-ion based traction batteries.

### BACKGROUND

Batteries for electric and plug-in hybrid vehicles are charged between uses to restore energy to the battery for the next use cycle. A vehicle may be connected to a charger that is connected to a power source. The charger is controlled to provide voltage and current to the battery to restore energy to the battery. The amount of current and voltage that may be applied depends on many factors. Present vehicle batteries may be fully charged over a number of hours. As electric and plug-in hybrid vehicles increase in popularity, there may be demand to reduce the length of time to charge the batteries.

### SUMMARY

A battery charging system includes at least one controller programmed to sustain charging of a battery cell until a cell voltage exceeds a recommended maximum voltage by an amount defined by a charging current and a battery resistance such that the cell voltage continues to increase during charging without a constant voltage phase. The charging current may be a generally constant current selected to cause the battery to acquire charge at a predetermined rate. The predetermined rate is a 15 C charge rate. The charging current may be based on a generally constant charge power level. The at least one controller may be further programmed to discontinue charging of the battery cell in response to the cell voltage becoming greater than the recommended maximum voltage by the amount defined by the current and the battery resistance. The at least one controller may be further programmed to estimate the battery resistance. The charging current may include an alternating current (AC) component and a direct current (DC) component, such that a magnitude of the AC component is less than a magnitude of the DC component, and the at least one controller may be further programmed to estimate the battery resistance based on the magnitude of the AC component and an AC voltage magnitude. The recommended maximum voltage may be a battery cell manufacturer defined maximum recommended voltage for a lithium-based battery cell. The recommended maximum voltage may be 4.2 volts.

A method of charging a battery cell includes charging, by a controller, the battery cell at a generally constant current selected to cause the battery cell to acquire charge at a predetermined rate such that a battery voltage continues to increase during charging without a constant voltage phase and terminating the charging when the battery voltage exceeds a recommended maximum voltage by an amount defined by the current and a battery resistance. The predetermined rate may be a 15 C charge rate. The method may further include estimating, by the controller, the battery resistance based on one or more voltage and current measurements. The method may further include adding an alternating current to the generally constant current such that an alternating current magnitude is less than a magnitude of the generally constant current, and estimating, by the controller, the battery resistance based on the alternating current magnitude and an alternating voltage magnitude. The recommended maximum voltage may be 4.2 volts.

A battery charging system includes at least one controller programmed to sustain charging of a battery cell at a generally constant current selected to cause the battery cell to acquire charge at a predetermined rate, and discontinue charging when a cell voltage exceeds a recommended maximum voltage by an amount defined by the current and a battery resistance to cause an immediate decrease in the cell voltage by approximately the amount. The predetermined rate may be such that the battery cell charges from 0 percent state of charge to 100 percent state of charge in less than 5 minutes. The amount may be a product of the generally constant current and the battery resistance. The recommended maximum voltage may be a manufacturer defined maximum voltage limit for a lithium-based battery cell. The at least one controller may be further programmed to add an alternating current component to the generally constant current, such that an alternating current magnitude is less than a magnitude of the generally constant current, and estimate the battery resistance based on the alternating current magnitude and an alternating voltage magnitude. The at least one controller may be further programmed to discontinue charging if a temperature of the battery cell is greater than a predetermined temperature. The at least one controller may be further programmed discontinue charging if the cell voltage does not exceed the recommended maximum voltage by the amount within a predetermined period of time.

### BRIEF DESCRIPTION OF THE DRAWINGS

FIG. 1 is a diagram of a hybrid vehicle illustrating typical drivetrain and energy storage components.

FIG. 2 is a diagram of a possible battery pack arrangement comprised of multiple cells, and monitored and controlled by a Battery Energy Control Module.

FIG. 3 is a diagram of an example battery cell equivalent circuit.

FIG. 4 is a graph that illustrates a possible open-circuit voltage (Voc) vs. battery state of charge (SOC) relationship for a typical battery cell.

FIG. 5 is a diagram of a battery charging system according to one possible embodiment.

FIG. 6 is a flowchart illustrating a possible controller-implemented method for charging a battery cell.

FIG. 7 is a graph illustrating cell voltage relaxation after removal of charge current.

FIG. 8 is a graph illustrating a possible fast charge cycle compared to a conventional charge cycle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

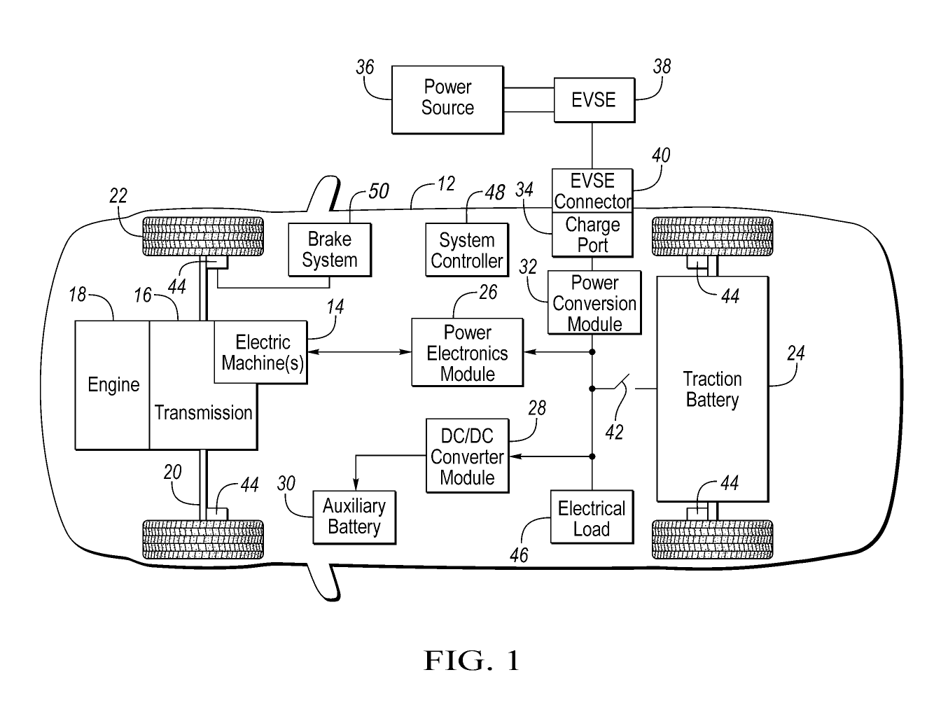

FIG. 1 depicts a typical plug-in hybrid-electric vehicle (PHEV). A typical plug-in hybrid-electric vehicle 12 may comprise one or more electric machines 14 mechanically connected to a hybrid transmission 16. The electric machines 14 may be capable of operating as a motor or a generator. In addition, the hybrid transmission 16 is mechanically connected to an engine 18. The hybrid transmission 16 is also mechanically connected to a drive shaft 20 that is mechanically connected to the wheels 22. The electric machines 14 can provide propulsion and deceleration capability when the engine 18 is turned on or off. The electric machines 14 also act as generators and can provide fuel economy benefits by recovering energy that would normally be lost as heat in the friction braking system. The electric machines 14 may also reduce vehicle emissions by allowing the engine 18 to operate at more efficient speeds and allowing the hybrid-electric vehicle 12 to be operated in electric mode with the engine 18 off under certain conditions.

A traction battery or battery pack 24 stores energy that can be used by the electric machines 14. A vehicle battery pack 24 typically provides a high voltage DC output. The traction battery 24 is electrically connected to one or more power electronics modules. One or more contactors (not shown) may isolate the traction battery 24 from other components when opened and connect the traction battery 24 to other components when closed. The power electronics module 26 is also electrically connected to the electric machines 14 and provides the ability to bi-directionally transfer energy between the traction battery 24 and the electric machines 14. For example, a typical traction battery 24 may provide a DC voltage while the electric machines 14 may require a three-phase AC current to function. The power electronics module 26 may convert the DC voltage to a three-phase AC current as required by the electric machines 14. In a regenerative mode, the power electronics module 26 may convert the three-phase AC current from the electric machines 14 acting as generators to the DC voltage required by the traction battery 24. The description herein is equally applicable to a pure electric vehicle. For a pure electric vehicle, the hybrid transmission 16 may be a gear box connected to an electric machine 14 and the engine 18 may not be present.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle loads. Other high-voltage loads, such as compressors and electric heaters, may be connected directly to the high-voltage without the use of a DC/DC converter module 28. The low-voltage systems may be electrically connected to an auxiliary battery 30 (e.g., 12V battery).

The vehicle 12 may be an electric vehicle or a plug-in hybrid vehicle in which the traction battery 24 may be recharged by an external power source 36. The external power source 36 may be a connection to an electrical outlet. The external power source 36 may be electrically connected to electric vehicle supply equipment (EVSE) 38. The EVSE 38 may provide circuitry and controls to regulate and manage the transfer of energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34. Alternatively, various components described as being electrically connected may transfer power using a wireless inductive coupling.

The various components discussed may have one or more associated controllers to control and monitor the operation of the components. The controllers may communicate via a serial bus (e.g., Controller Area Network (CAN)) or via discrete conductors. In addition, a system controller 48 may be present to coordinate the operation of the various components.

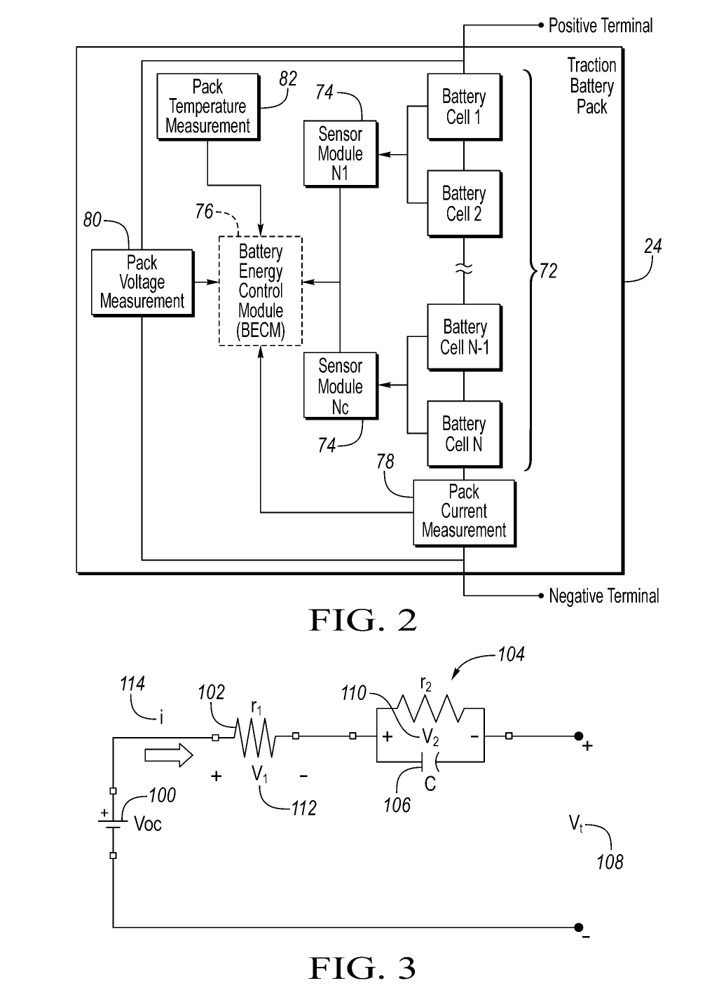

A traction battery 24 may be constructed from a variety of chemical formulations. Typical battery pack chemistries may be lead acid, nickel-metal hydride (NIMH) or Lithium-Ion. FIG. 2 shows a typical traction battery pack 24 in a simple series configuration of N battery cells 72. Other battery packs 24, however, may be composed of any number of individual battery cells connected in series or parallel or some combination thereof. A typical system may have a one or more controllers, such as a Battery Energy Control Module (BECM) 76 that monitors and controls the performance of the traction battery 24. The BECM 76 may monitor several battery pack level characteristics such as pack current 78, pack voltage 80 and pack temperature 82. The BECM 76 may have non-volatile memory such that data may be retained when the BECM 76 is in an off condition. Retained data may be available upon the next key cycle.

In addition to the pack level characteristics, there may be battery cell 72 level characteristics that are measured and monitored. For example, the terminal voltage, current, and temperature of each cell 72 may be measured. A system may use a sensor module 74 to measure the battery cell 72 characteristics. Depending on the capabilities, the sensor module 74 may measure the characteristics of one or multiple of the battery cells 72. The battery pack 24 may utilize up to N, sensor modules 74 to measure the characteristics of all the battery cells 72. Each sensor module 74 may transfer the measurements to the BECM 76 for further processing and coordination. The sensor module 74 may transfer signals in analog or digital form to the BECM 76. In some embodiments, the sensor module 74 functionality may be incorporated internally to the BECM 76. That is, the sensor module 74 hardware may be integrated as part of the circuitry in the BECM 76 and the BECM 76 may handle the processing of raw signals.

It may be useful to calculate various characteristics of the battery pack. Quantities such a battery power capability and battery state of charge may be useful for controlling the operation of the battery pack as well as any electrical loads receiving power from the battery pack. Battery power capability is a measure of the maximum amount of power the battery can provide or the maximum amount of power that the battery can receive. Knowing the battery power capability allows electrical loads to be managed such that the power requested is within limits that the battery can handle.

Battery pack state of charge (SOC) gives an indication of how much charge remains in the battery pack. The battery pack SOC may be output to inform the driver of how much charge remains in the battery pack, similar to a fuel gauge. The battery pack SOC may also be used to control the operation of an electric or hybrid-electric vehicle. Calculation of battery pack SOC can be accomplished by a variety of methods. One possible method of calculating battery SOC is to perform an integration of the battery pack current over time. This is well-known in the art as ampere-hour integration.

A battery cell may be modeled as a circuit. FIG. 3 shows one possible battery cell equivalent circuit model (ECM). A battery cell may be modeled as a voltage source (V_{oc}) 100 having associated resistances (102 and 104) and capacitance 106. V_{oc} 100 represents the open-circuit voltage of the battery. The model includes an internal resistance, r₁ 102, a charge transfer resistance, r₂ 104, and a double layer capacitance, C 106. The voltage V₁ 112 is the voltage drop across the internal resistance 102 due to current 114 flowing through the circuit. The voltage V₂ 110 is the voltage drop across the parallel combination of r₂ 104 and C 106 due to current 114 flowing through the combination. The voltage Vₜ 108 is the voltage across the terminals of the battery (terminal voltage).

Because of the battery cell impedance, the terminal voltage, Vₜ 108, may not be the same as the open-circuit voltage, V_{oc} 100. The open-circuit voltage, V_{oc} 100, may not be readily measurable as only the terminal voltage 108 of the battery cell is accessible for measurement. When no current 114 is flowing for a sufficiently long period of time, the terminal voltage 108 may be the same as the open-circuit voltage 100. Upon discontinuing the current 114, the terminal voltage 108 may relax or decay to the open-circuit voltage 100 over a period of time as modeled by the capacitive element. In a steady-state condition in which the current 114 is constant, the impedance may be modeled as the sum of the resistive elements r₁ 102 and r₂ 104. When current 114 is flowing, V_{oc} 100 may not be readily measurable and the value may need to be inferred based on the circuit model. The parameter values r₁ 102, r₂ 104, and C 106 may be known or unknown. The value of the parameters may depend on the battery chemistry. Other battery models are possible and the methods described are not dependent upon the model that is chosen.

During charging, a charging voltage may be applied to the battery terminals 108. Current 114 may flow through the battery based on the resistance 112 and the open-circuit voltage 100.

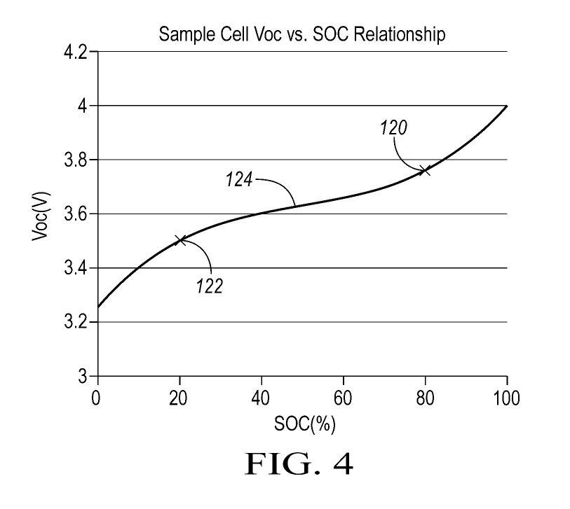

For a typical Lithium-Ion battery cell, there is a relationship between SOC and the open-circuit voltage (V_{oc}) such that V_{oc}=f(SOC). FIG. 4 shows an example curve 124 showing the open-circuit voltage V_{oc} as a function of SOC. The relationship between SOC and V_{oc} may be determined from an analysis of battery properties or from testing the battery cells. The function may be such that SOC may be calculated as f¹(V_{oc}). The function or the inverse function may be implemented as a table lookup or an equivalent equation. The exact shape of the curve 124 may vary based on the exact formulation of the Lithium-Ion battery. The voltage V_{oc} changes as a result of charging and discharging of the battery. Note that the curve may vary based on the battery chemistry. For example, the voltage associated with 100% SOC may change for different battery chemistries.

The battery impedance may change over operating conditions of the battery. The resistance values may vary as a function of the battery temperature. For example, the resistance value, r₁ 102, may decrease as temperature increases and the capacitance, C 106, may increase as the temperature increases. The resistance value may also depend on the state of charge of the battery.

The battery impedance parameter values, r₁ 102, r₂ 104, and C 106 may also change over the life of the battery. For example, the resistance value may increase over the life of the battery. The increase in resistance may vary as a function of temperature and state of charge over the life of battery. Higher battery temperatures may cause a larger increase in battery resistance over time. For example, the resistance for a battery operating at 80° C. may increase more than the resistance of a battery operating at 50° C. over a period of time. At a constant temperature, the resistance of a battery operating at 50% state of charge may increase more than the resistance of a battery operating at 90% state of charge. These relationships may be battery chemistry dependent.

As seen in FIG. 4, as the SOC increases, the open-circuit voltage generally increases as well. As the battery is charged, the SOC increases and the open-circuit voltage rises. The rate of voltage increase may depend on the state of charge. In order to sustain the same amount of current, the terminal voltage may be increased.

One factor relating to rechargeable batteries in vehicles is the amount of time required to recharge the battery. Drivers may prefer that electric vehicle batteries be recharged in a short amount of time. The amount of time may be considered to be equivalent to the amount of time spent refueling a conventional gasoline engine vehicle. Existing battery charging strategies generally take a much longer period of time to recharge the vehicle battery. Recharging a vehicle battery presently requires substantially more time than refueling the conventional gasoline engine vehicle.

There are several factors that may prevent lithium-ion based vehicle batteries from fast charging. A battery cell includes a positive electrode and a negative electrode. A common perception is that excessive lithium may build up on the surface of the negative electrodes, causing detrimental side reactions because lithium ions cannot diffuse quickly enough toward storage sites within graphite particles during a fast charge. In addition, vehicle manufacturers attempt to balance charging hardware capability and charging hardware cost so that consumers do not pay for expensive chargers along with the lithium-ion battery. Vehicle manufacturers generally choose less powerful lithium-ion batteries which are cheaper for a given energy content. Finally, fast charging infrastructure is not yet widely available.

To charge a battery, a charging voltage and current are generally applied to the terminals of the battery. The charging voltage may be greater than the internal cell voltage such that current flows into the battery. Charging strategies may be developed to select the charging voltage and current to achieve a desired charging rate. Battery manufacturers typically specify a maximum charge voltage that may be applied to the terminals of the battery. Vehicle manufacturers generally design control strategies that limit the charging voltage to not exceed the cell manufacturer recommended maximum charge voltage.

One characteristic of the fast battery charging system is the dynamic calculation of a maximum charge voltage with an estimated IR drop compensation. The maximum charge voltage may be defined as:

Vₘₐₓ*=Vₘₐₓ+iR (1)

where Vₘₐₓ is a conventional maximum charge voltage recommended by the battery cell manufacturer, i is the battery current, and R is an internal battery cell resistance.

A charging system controller may measure the battery current, i, during the charging process. The resistance, R, may be estimated during charging. The resistance value may be estimated or measured at the onset of charging, during charging, or after charging. The resistance may be a predetermined resistance value based on battery life. A variety of methods may be utilized to provide a real-time estimation of the resistance. A first method may be to simply calculate the resistance, R, based on quotient of voltage (V) and current (I), where V is a voltage across the resistance and I is the measured current flowing through the battery. One method to calculate the resistance may be to consider two separate cell voltage measurements, V₁ and V₂, sampled at different times with associated current measurements, I₁ and I₂. The relationship between the resistance value and the voltage and current measurements may be expressed as follows:

V₁=V_{oc}¹+I₁R (2)

V₂=V_{oc}²+I₂R (3)

where V_{oc} is an estimate of the open-circuit voltage of the cell at the sampling time. An estimate of V_{oc} may be calculated if a value for SOC is known (see FIG. 4.) Taking a difference between the equations yields:

V₁−V₂=(V_{oc}¹−V_{oc}²)+(I₁−I₂)R (4)

The time interval between sample values of the voltage and current may be selected to obtain an accurate result. A first voltage and current sample may be taken just before charging is started (current approximately zero). A second voltage and current sample may be taken just after charging has started (current non-zero). At this point, the open-circuit voltage, V_{oc}, should not have changed and the resistance may be calculated as:

$$R = \frac{Δ V}{Δ I} \qquad ( 5 )$$

where ΔV is the difference between two cell terminal voltages and AI is the difference between two current measurements. This technique may be useful to calculate the resistance at the start of charging. During charging, the V_{oc} values may be estimated based on SOC and the full equation (4) may be utilized.

An alternative resistance measurement scheme may utilize an alternating current and voltage to calculate the resistance. The charger may output a generally constant current (e.g., DC current). An alternating current (AC) component may be added to a DC component. The alternating current component may have a given frequency and amplitude. The amplitude of the AC component may be substantially less than the DC component. The result may be a voltage waveform having an AC component and a DC component. The frequency and amplitude of the AC voltage component may be measured. The resistance may be calculated as the amplitude of the AC voltage divided by the amplitude of the AC current. The resistance may be calculated as the quotient of the voltage magnitude and the current magnitude. In this manner, the resistance value may be continually determined during charging. This technique may permit the system to detect changes in the resistance that may occur due to temperature or other factors during charging.

The AC resistance measurement may require additional circuitry to add the AC component to the DC component. A typical frequency for the AC component may be 1000 Hz, but other frequency values are possible. The amplitude of the AC component may be substantially smaller than the DC component such that the AC component appears to be a ripple on the DC component. Measurement circuitry may include additional filters to filter out the AC component on some measurement channels. For example, a high-pass filter may be used to filter out the DC component. The amplitude of the AC signal may be determined in several ways. For example, the AC value may be sampled via an A/D input and the controller may determine the maximum value. Alternatively, a peak detector circuit may be used and the output sampled via an A/D input of the controller. This may be implemented on both the voltage and current signal. The AC component may be periodically switched such that the AC component is not always present in the charging current. In some implementations, the resistance may be measured before charging is initiated. In such an implementation, only the AC component may be applied without the DC component.

Previous battery charging systems adopt a constant maximum voltage that is the manufacturer recommended voltage limit, Vₘₐₓ. Previous charging strategies utilize a constant current phase followed by a constant voltage phase at the maximum recommended voltage. During the constant voltage charging phase, the current decreases as the open-circuit voltage increases with state of charge. The level of constant current charge is typically lower than a 1 C rate. A 1 C rate of charging indicates that a battery will be fully charged in one hour. The maximum charge voltage is typically fixed in prior charging systems. A C-rate greater than one charges or discharges the battery 24 in less than one hour (e.g., 2-C=0.5 hours), while a C-rate less than one charges or discharges the battery 24 in more than one hour (e.g., 0.1-C=10 hours). For example, for LiCoO₂/Graphite battery cells the manufacturer recommended voltage limit may be set to 4.1V.

There are three levels of charging defined for electric vehicle battery charging. Level 1 charging operates at 1.4 kW and may utilize an ordinary household electrical outlet. A high-capacity battery may take many hours to fully recharge in a level 1 system. Level 2 charging operates at 3.3 kW and utilizes a 240V electrical outlet. Level 3 charging operates at greater than 6.6 kW and generally requires an expensive charge station. Conventional charging algorithms generally adopt a fixed maximum charge voltage limit.

A method of fast charging a vehicle traction battery may utilize a charge voltage that is greater than the recommended maximum charge voltage as described herein. Charging may be constant current, constant voltage, constant power, or any combination thereof.

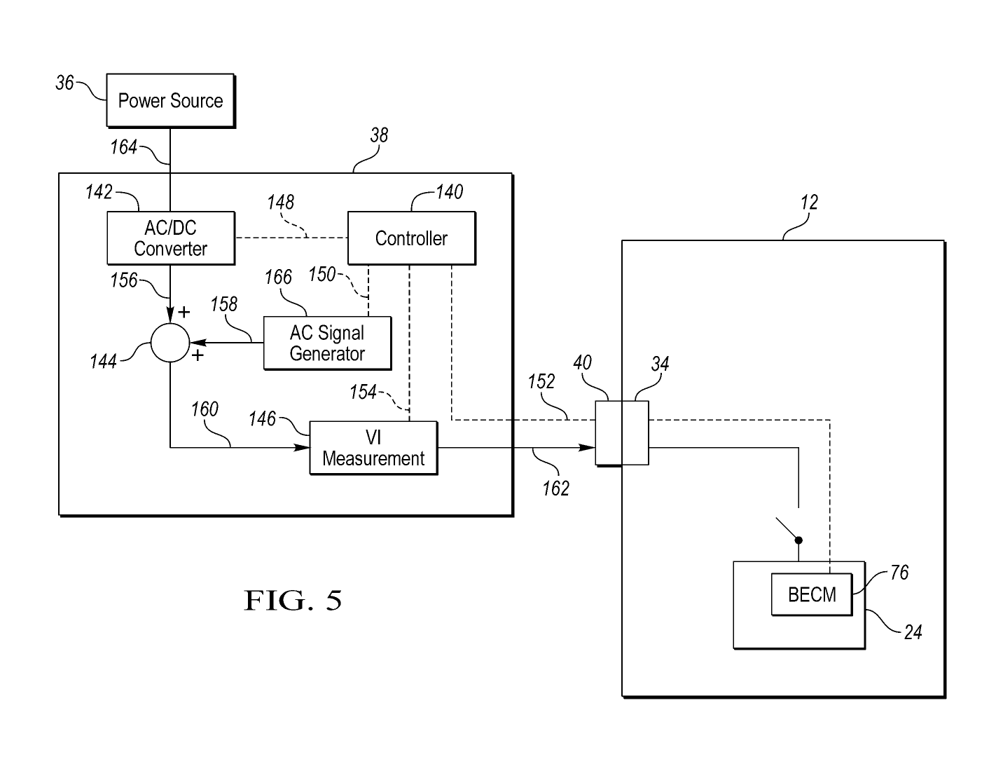

FIG. 5 depicts a block diagram of one possible implementation of a battery charging system. The EVSE 38 may include a controller 140 for managing and controlling operation of the off-board charging system. The power source 36 may be electrically connected to the EVSE 38. One or more electrical connections may be provided. The power source 36 may connect to an AC/DC converter 142 that converts an AC input voltage signal 164 into a DC output voltage signal 156. The controller 140 may control operation of the AC/DC converter 142 via a first control signal interface 148. The first control signal interface may include one or more electrical connections.

The controller 140 may also control an AC signal generator 166 via a second control signal interface 150. The second control signal interface 150 may include one or more electrical connections. The AC signal generator 166 may provide an alternating voltage output signal 158 for use in estimating the resistance as described herein. The alternating voltage output signal 158 may be added to the DC output voltage signal 156 using a summing circuit 144. A combined output 160 may be output from the summing circuit 144 which may include a DC component and an AC component.

A voltage and current measurement module 146 may interface with the combined output 160 to provide voltage and current data to the controller 140. A third control signal interface 154 may connect the controller 140 and the measurement module 146 and may include one or more electrical connections. An EVSE charging output 162 may be provided to the EVSE connector 40. The EVSE connector 40 may be electrically connected to the vehicle charge port 34 to provide the EVSE charging output 162 to the traction battery 24. The BECM 76 may monitor and control the traction battery 24 operation during charging. A fourth control signal interface 152 may be provided to facilitate communication between the off-board controller 140 and the on-board controller 76. The fourth control signal interface 152 may include one or more electrical connections and may include a serial communication connection.

Note that the charging strategy is applicable to a single cell as well as a traction battery that includes a plurality of cells. The recommended voltage limit for the traction battery may be defined as the recommended voltage limit for the battery cell multiplied by the number of cells connected in series. During charging, each cell may be charged and monitored according to the fast charging strategy.

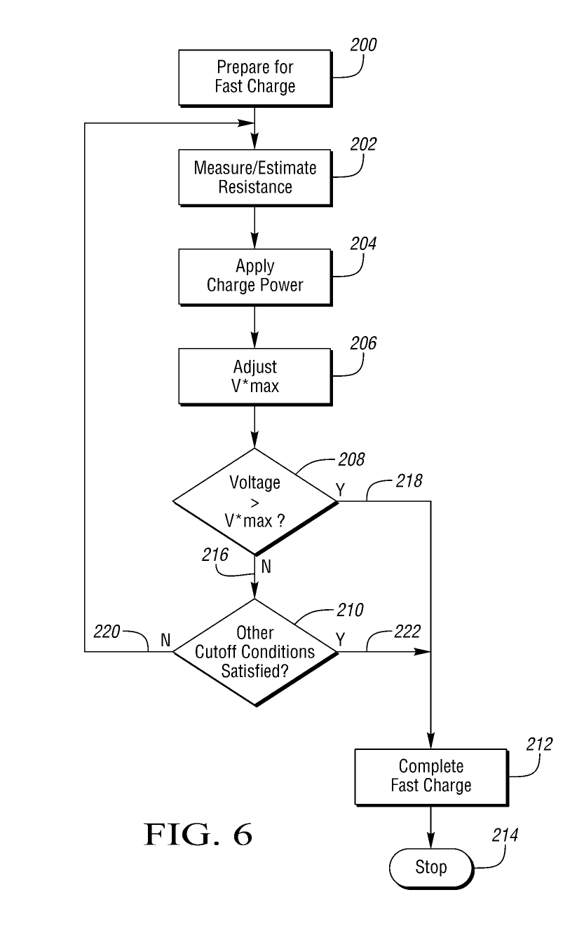

FIG. 6 depicts a flowchart for fast-charging a lithium-ion battery. A first operation 200 may be implemented to prepare for fast battery charging. Operation 200 may implement various preliminary tasks to ensure that the system is ready for fast charging. Some functions of operation 200 may be to check for the presence of a connected charger and the status of the charger.

Operation 202 may be implemented in which the battery resistance is measured or estimated. The resistance value may be determined in real-time based on current and voltage measurements. The resistance value may be continually learned throughout the charging process and the charging algorithm may adapt to the present resistance value. The resistance value may be a predetermined value based on a table stored in the controller memory. The resistance value may also be calculated at the onset of charging. The resistance value may be estimated using any of the strategies described herein.

Operation 204 may be implemented to apply charge power to the battery. The on-board controller 76 may communicate with the charger 38 to facilitate charging. Information may be exchanged between the on-board controller 76 and the off-board controller 140. The charger 38 may control the current provided to the battery 24 to a generally constant current level. The generally constant current level may be selected to cause the battery to acquire charge at a selected rate (e.g., a rate greater than 1 C). The generally constant current may be selected to charge the battery at a selected power level. The charger 38 may adjust the voltage provided to the battery 24 to achieve the generally constant current level. In some implementations, the charging current may be based on a generally constant charge power level.

Operation 206 may be implemented in which the resistance and current measurement values may be used to update a voltage limit, Vₘₐₓ*, as described herein. The voltage limit may be the maximum voltage allowed at the terminals of the traction battery 24 during charging. Note that as the resistance and current change during charging, the voltage limit may change in response.

During charging, certain conditions may be monitored to indicate when charging should be terminated. The battery terminal voltage may be measured and monitored during charging. At operation 208, the battery terminal voltage may be compared to the voltage limit, Vₘₐₓ*, to determine if charging is completed. If the battery terminal voltage is greater than Vₘₐₓ*, then path 218 may be taken and fast charging may be completed at operation 212.

If the battery terminal voltage is not greater than Vₘₐₓ*, then path 216 may be taken. In this case, operation 210 may be implemented to determine if other cutoff conditions are satisfied. A possible cutoff condition may be a temperature check of the battery or other components in the system. It may be desirable to prevent the battery temperature from increasing above a predetermined temperature. To prevent damage to the battery, charging may be stopped when the battery temperature is greater that the predetermined temperature.

Another cutoff condition may be a state of charge check. It may be desirable for the battery to operate in a particular SOC range. To prevent overcharging of the battery, a maximum battery SOC limit may be defined. When the SOC of the battery is greater than the maximum battery SOC limit, charging may be stopped. The maximum battery SOC limit may indicate when the battery is fully charged.

Another cutoff condition may be based on a charging time. If other cutoff conditions are not satisfied within a predetermined time limit, charging may be stopped. The predetermined time limit may be defined as a time in which a normally functioning battery and charging system should achieve a full charge of the battery.

Another cutoff condition may be based on a minimum terminal voltage. If charging is in progress and the measured battery voltage is below a minimum voltage threshold, the charging may not be working properly. The charging process may be terminated.

An additional cutoff condition may be a user generated end of charging request. This may be a signal from the charger. A cutoff condition may also be the removal of the charge connector from the charge port.

The cutoff conditions may be used in any combination. One or all of the conditions may be checked to determine when to terminate charging. When one or more of the selected cutoff conditions are satisfied, charging may be terminated. The charger 38 may cease providing current and voltage to the battery 24 and may initiate any post-charging operations.

If the cutoff conditions are satisfied, then path 222 may be followed in which fast charging is completed with operation 212. Operation 212 may include controlling the charger 38 to discontinue providing current and voltage to the battery 24. Various shutdown operations may be implemented. Completion of fast charging may include thermal management of various components to ensure that each component is at a proper temperature for shutting down. Various heating or cooling components may be operated to facilitate thermal management during and after the charging process. After fast charging is completed, execution may stop at operation 214.

If the cutoff conditions are not satisfied, then path 220 may be taken in which case, the procedure transitions to operation 202 and repeats. The charging process may continue until one or more of the cutoff conditions are satisfied.

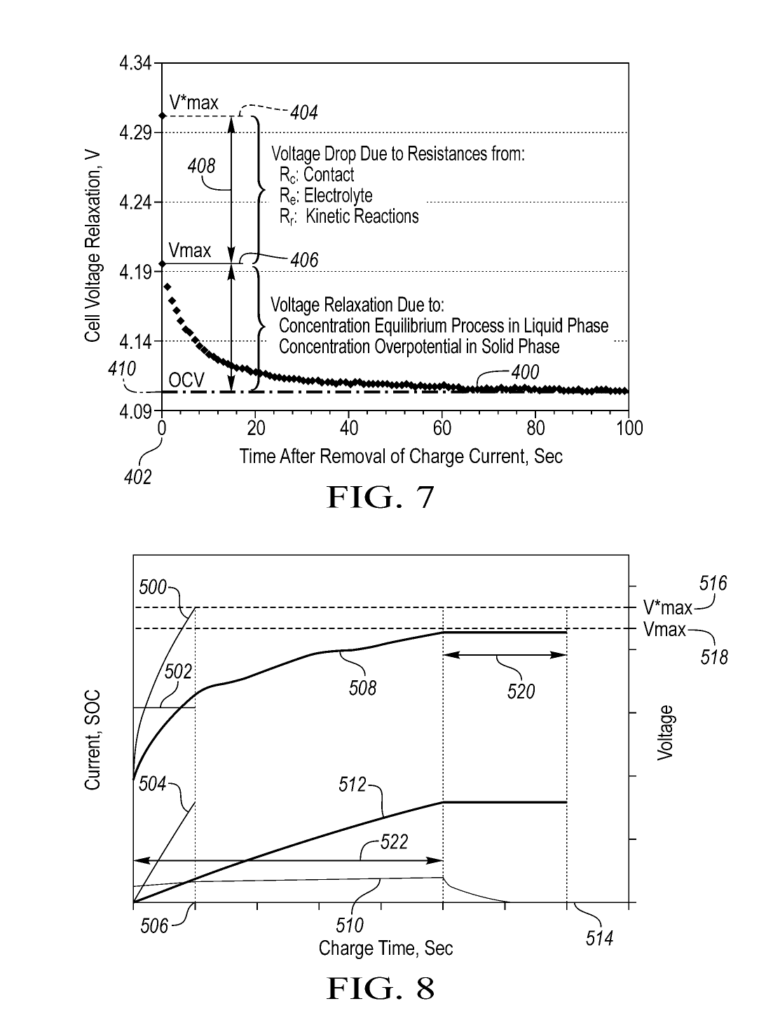

Battery voltage is a result of the electrochemical potential of the battery (also referred to as the open-circuit voltage), concentration over-potentials of solid and electrolyte, electrochemical reactions kinetic over-potential, and IR drops due to internal cell resistances. FIG. 7 depicts an example of the voltage response 400 immediately after a charge cycle is terminated. The time immediately after charge cycle termination may be referred to as the relaxation time. The voltage response includes voltage components due to different battery processes. Some voltage components are related to battery safety limits such as open-circuit voltage and solid concentration over-potentials, while the other components have minimal detrimental effect.

The algorithm described herein takes advantage of IR compensation and allows the battery to accept a full scale charge without damage. As shown in FIG. 7, upon removal of the charging current at a time zero 402, there is a rapid cell voltage drop 408 from Vₘₐₓ* 404 to Vmax 406. The immediate cell voltage drop 408 results from the resistive portions that dissipate quickly. The resistance may be from contacts, electrolyte and kinetic reactions.

Over a longer period of time, the cell voltage decays from Vmax 406 to the open-circuit voltage 410 due to concentration equilibrium processes in the liquid phase and concentration overpotential in the solid phase. These processes act more slowly than the resistive processes. Over time, the cell voltage will decay to the nominal open-circuit voltage 410.

When the charging current and voltage are removed after charging, the terminal voltage may drop 408 immediately to a lower voltage level. This drop 408 is due to the resistive components of the battery cell. When a lower charging current is provided, such as prior art charging schemes, this voltage drop 408 may be less noticeable. After the initial resistive drop 408, the voltage decays to the open-circuit voltage 410 according to the capacitive-like properties of the battery cell. This decay may be due to chemical processes within the battery cell.

The method allows faster charging of Lithium-ion battery packs by increasing the maximum voltage that can be applied during charging. The higher voltage accounts for resistive effects within the battery and allows a dramatic increase in the charging time of the battery. FIG. 8 is a graph illustrating the charging time of the fast charging method compared to a conventional charging strategy. The conventional strategy employs a constant current phase 522 followed by a constant voltage phase 520. During the constant current phase 522 a generally constant current 510 is supplied for charging. The voltage 508 increases until the recommended maximum voltage, Vₘₐₓ 518. The constant voltage phase 520 is entered in which the voltage 508 is held at Vₘₐₓ 518. During this time, the current 510 decreases. The state of charge 512 curve increases slowly during the constant voltage phase 520 as current is decreasing. The end of charging of the conventional scheme may end when the desired state of charge is achieved 514.

The fast charging logic is also depicted. A generally constant current 502 is applied to the battery. The generally constant current 502 of the fast charging method may be substantially greater than the constant current 510 of the conventional charging method. The voltage 500 increases during charging and can exceed Vₘₐₓ 518. Charging may be discontinued when the voltage increase to Vₘₐₓ* 516. Charging may be complete at a time 506 that is substantially less than convention charge time 514.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A battery charging system comprising:
at least one controller programmed to sustain charging of a battery cell until a cell voltage exceeds a recommended maximum voltage by an amount defined by a charging current and a battery resistance such that the cell voltage continues to increase during charging without a constant voltage phase.

2. The charging system of claim 1 wherein the charging current is a generally constant current selected to cause the battery to acquire charge at a predetermined rate.

3. The charging system of claim 2 wherein the predetermined rate is a 15 C charge rate.

4. The charging system of claim 1 wherein the charging current is based on a generally constant charge power level.

5. The charging system of claim 1 wherein the at least one controller is further programmed to estimate the battery resistance.

6. The charging system of claim 1 wherein the charging current includes an alternating current (AC) component and a direct current (DC) component such that a magnitude of the AC component is less than a magnitude of the DC component, and the at least one controller is further programmed to estimate the battery resistance based on the magnitude of the AC component and an AC voltage magnitude.

7. The charging system of claim 1 wherein the recommended maximum voltage is a battery cell manufacturer defined maximum recommended voltage for a lithium-based battery cell.

8. The charging system of claim 1 wherein the recommended maximum voltage is 4.2 volts.

9. A method of charging a battery cell comprising:
charging, by a controller, the battery cell at a generally constant current selected to cause the battery cell to acquire charge at a predetermined rate such that a battery voltage continues to increase during charging without a constant voltage phase; and
terminating the charging when the battery voltage exceeds a recommended maximum voltage by an amount defined by the current and a battery resistance.

10. The method of claim 9 wherein the predetermined rate is a 15 C charge rate.

11. The method of claim 9 further comprising estimating, by the controller, the battery resistance based on one or more voltage and current measurements.

12. The method of claim 9 further comprising adding an alternating current to the generally constant current such that an alternating current magnitude is less than a magnitude of the generally constant current, and estimating, by the controller, the battery resistance based on the alternating current magnitude and an alternating voltage magnitude.

13. The method of claim 9 wherein the recommended maximum voltage is 4.2 volts.

14. A battery charging system comprising:
at least one controller programmed to
sustain charging of a battery cell at a generally constant current selected to cause the battery cell to acquire charge at a predetermined rate, and
discontinue charging when a cell voltage exceeds a recommended maximum voltage by an amount defined by the current and a battery resistance to cause an immediate decrease in the cell voltage by approximately the amount.

15. The charging system of claim 14 wherein the predetermined rate is such that the battery cell charges from 0 percent state of charge to 100 percent state of charge in less than 5 minutes.

16. The charging system of claim 14 wherein the amount is a product of the generally constant current and the battery resistance.

17. The charging system of claim 14 wherein the recommended maximum voltage is a manufacturer defined maximum voltage limit for a lithium-based battery cell.

18. The charging system of claim 14 wherein the at least one controller is further programmed to add an alternating current component to the generally constant current such that an alternating current magnitude is less than a magnitude of the generally constant current, and estimate the battery resistance based on the alternating current magnitude and an alternating voltage magnitude.

19. The charging system of claim 14 wherein the at least one controller is further programmed to discontinue charging if a temperature of the battery cell is greater than a predetermined temperature.

20. The battery charging system of claim 14 wherein the at least one controller is further programmed to discontinue charging if the cell voltage does not exceed the recommended maximum voltage by the amount within a predetermined period of time.
